(19) United States
(12) Patent Application Publication
(10) Pub. No.: US 2025/0232339 A1
(43) Pub. Date: Jul. 17, 2025

(54) Incentivized Crowd Funding System with Blockchain Security for Internal Innovation by an Organization

(71) Applicant: Solventum Intellectual Properties Company, Maplewood, MN (US)

(72) Inventors: Audrey A. Sherman, Woodbury, MN (US); Michael E. Swenson, Lino Lakes, MN (US); Shaun G. Braun, Los Altos, CA (US)

(21) Appl. No.: 18/876,221

(22) PCT Filed: May 24, 2023
(86) PCT No.: PCT/IB2023/055351

§ 371 Date: Dec. 18, 2024

Related U.S. Application Data
(60) Provisional application No. 63/354,352, filed on Jun. 22, 2022.

(51) Int. Cl. G06Q 30/0279; G06Q 10/0631; G06Q 20/38; G06Q 30/0207; G06Q 40/04; G06Q 50/18

(52) U.S. Cl. CPC G06Q 30/0279; G06Q 10/06313; G06Q 20/381; G06Q 30/0207; G06Q 40/04; G06Q 50/184; G06Q 2220/00

(57) ABSTRACT

Crowd funding for innovation includes distributing a proposal with a description of a project idea, an amount of funds requested, and a time frame for raising the funds. Ownership of the project is transferred to an entity or between entities, which receives contributions from contributors and for each of the received contributions converts the contribution to a corresponding amount of virtual coin, performs a blockchain operation on the coin, and adds the contribution to the funds. The virtual coin is subject to a blockchain operation to uniquely identify and trace it, establishing confidence in the transaction between contributor and entity or between entities. If the funding goal is complete within the time frame, the entity converts the coins to fiat currency and releases the money to the requestor. After completion of the project, the entity or entities determines if the project is successful and can commercialize successful projects. For certain successful projects, the entity or entities can also distribute funds to the contributors.

### BACKGROUND

Crowd funding is a way to fund a project by raising many small amounts of money from a large group of people. An example is the Kickstarter innovation web site from Kickstarter, Inc. (based in Greenpoint, Brooklyn, US). The Kickstarter site can be used to fund creative projects via crowd funding with Kickstarter retaining a portion of the funds as its fee. The creator of the project retains complete ownership of it. The backers are often helping to fund their friends' project and can see the creative process as it happens. Also, the backers may receive a copy of the finished creative work such as a book or CD. Since the project creator retains ownership of the project, this type of funding may not be desirable for a corporate funding of projects or ideas where the corporation wants to retain ownership of the project in order to commercialize it if the project is successful.

### SUMMARY

A computer-implemented method of crowd funding for innovation, consistent with the present invention, includes distributing a proposal with a description of a project idea, an amount of funds requested, and a time frame for raising the funds. Ownership of the project is transferred to an entity. In response to the proposal, the entity receives contributions from contributors and for each of the received contributions the entity converts the contribution to a corresponding amount of coin subject to a blockchain operation, and adds the contribution to the funds. The entity releases an amount of money corresponding with the amount of coin in the funds if the funding goal is met within the time frame and within a bank amount of funds available for the project. The entity determines if the project is successful after the money is released. If the project is successful, the entity can optionally distribute the funds or a bonus to the contributors, converted from the coin.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram of a system for incentivized crowd funding;

FIG. 2 is a flow chart of a method for receiving a proposal for crowd funding;

FIGS. 3A and 3B are a flow chart of a method for incentivized crowd funding;

FIG. 4 is a diagram of a user interface for a requestor to submit a proposal;

FIG. 5 is a diagram of a user interface for making a contribution to a proposal;

FIG. 6 is a diagram of a user interface for distributing coin to a pool of potential contributors;

FIG. 7 is a diagram of an exemplary icon for a coin;

FIG. 8 is a diagram of a user interface for submitting a proposal and monitoring the status of it; and

FIG. 9 is a diagram of a blockchain structure for the crowd funding system.

### DETAILED DESCRIPTION

Embodiments of this invention include the combination of a crowd sourced idea generation electronic web site with crowd sourced funding for corporate innovation. The actual funding comes from internal corporate sources based upon contributions from individuals, since the ideas and projects that will be created and funded and ultimately produced will be the sole property of the company that employs the crowd. But the decision as to what to fund will be entirely up to the individuals (internal crowd) that are placing the funds on the projects and ideas as they see fit. The ideas are crowd sourced as well. This combination provides a new way for corporate innovation and commercialization of ideas, for example. Examples of a crowd funding systems for innovation are disclosed in U.S. Pat. Nos. 10,896,391 and 10,740,734, both of which are incorporated herein by reference as if fully set forth.

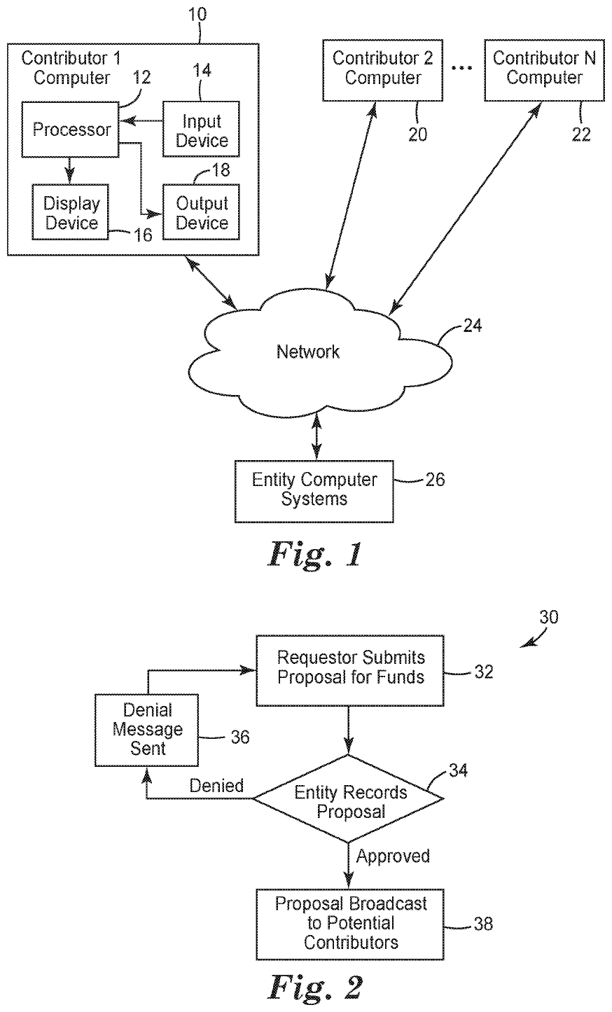

FIG. 1 is a diagram of a system for incentivized crowd funding. The system includes contributor computers 10, 20, and 22 for use in contributing to a project. Contributor computer 10 can include a processor 12, an input device 14 for receiving information or commands, an electronic display device 16 for displaying information, and an output device 18 for outputting information in other forms such as audible information. Contributor computers 20 and 22 can include the same components, or be configured in the same way, as contributor computer 10. The contributor computers are electronically coupled to a network 24 such as the Internet or a corporate intranet. Entity computer systems 26 are also electronically coupled with network 24. Entity computer systems 26 can include computer applications used within large or small organizations, and such systems can include electronic mail (email), accounting systems, record keeping systems, electronic databases, and computers for hosting internal web sites. Only three contributor computers are shown for illustrative purposes, and the system can be scaled to include a large number of contributor computers, sufficient to fund a project, coupled to entity computer systems 26 via network 24. The entity can be, for example, a corporation, partnership, or other organization involved in developing ideas for innovation. The entity controls, directly or indirectly, entity computer systems 26.

FIG. 2 is a flow chart of a method 30 for receiving a proposal for crowd funding. Method 30 can be implemented in software for execution by a computer, such as one of the contributor computers or other computer coupled to entity computer systems 26 via network 24. In method 30, a requestor electronically submits a proposal for funds (step 32). A requestor can be, for example, a person such as an employee or consultant of the entity. The requestor can also be, for example, a group of persons such as a team of employees of the entity.

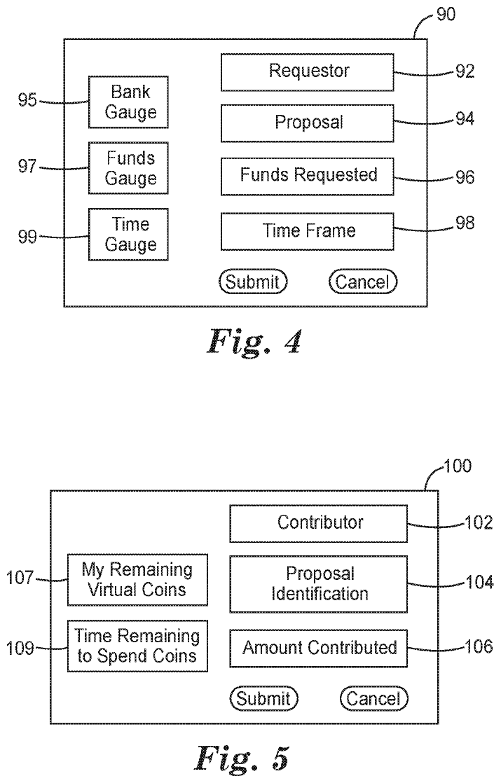

FIG. 4 is a diagram of a user interface 90 for a requestor to submit a proposal. User interface 90 can be displayed on an electronic display device of a computer for the requestor to submit information. User interface 90 includes a section 92 to identify the requestor, a section 94 to describe the proposal or idea, a section 96 to identify the amount of funds requested, and a section 98 to indicate a time frame to generate the requested funds. The proposal in user interface 90 can be described in text, photos, video, or other multi-media content. User interface 90 can also include a bank gauge 95, a funds gauge 97, and a time gauge 99 to provide a visual representation of the following: the amount of coins remaining in the bank and available for this proposal in gauge 95; the funds currently obtained or collected in gauge 97; and the time remaining to reach the funding goal in gauge 99. Gauges 95, 97, and 99 can be implemented with icons in user interface 90. For example, bank gauge 95 can include a bar that decreases in length as coins from the bank are used to fund this proposal, funds gauge 97 can include a bar that increases in length as funds are collected, and time gauge 99 can include a clock that counts down showing the amount of time remaining. Gauges 95, 97, and 99 can provide a way for both the requestor and potential contributors to view the status of the crowd funding for the proposal.

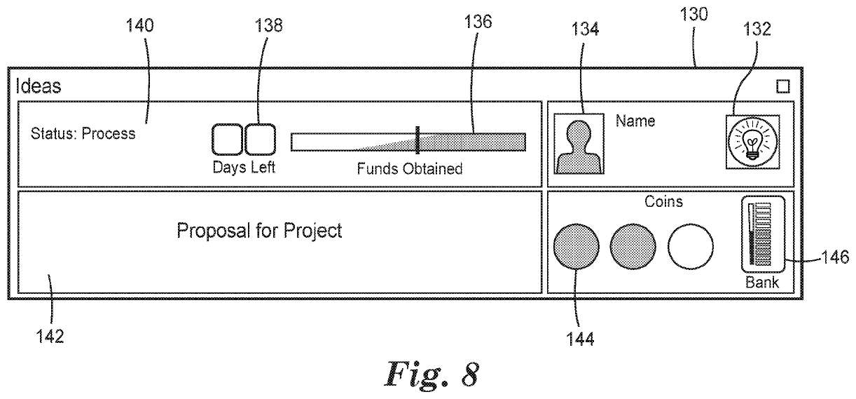

FIG. 8 is a diagram of another, and a stylized, user interface 130 for submitting a proposal and monitoring the status of it. User interface 130 can be displayed on an electronic display device of a computer for the requestor to submit a proposal for a project and monitor status information relating to the proposal. User interface 130 can be implemented, for example, as a customizable template for various groups within the entity.

User interface 130 includes a section 132 to indicate how many proposals this requestor has submitted. For example, different types of icons displayed in section 132 can indicate how many proposals this requestor has submitted and, as another example, the light bulb icon shown in FIG. 8 can indicate that this proposal is the first idea submitted by this requestor. Instead of displaying different types of icons, the light bulb icon can optionally be shown in different colors to provide an indication of how many proposals this requestor has submitted or include a displayed numeral with the icon to indicate the number of submitted proposals. Section 132, or other parts of user interface 130, can also include icons, in addition to or instead of the light bulb icon, to indicate other information relating to the requestor. For example, particular types of badge icons can be displayed and used to indicate how many proposals the requestor has contributed to, how many of the proposals the requestor has contributed to have been deemed successful, or how many of the requestor's proposals have been deemed successful. For example, a badge icon of a displayed gold circle can indicate this requestor has contributed to at least three proposals resulting in successful projects, and a badge icon of a displayed silver circle can indicate this requestor has contributed to at least one proposal resulting in a successful project. As another example, a badge icon of a displayed gold star can indicate this requestor has submitted at least three proposals resulting in successful projects, and a badge icon of a displayed silver star can indicate this requestor has submitted at least one proposal resulting in a successful project. Displaying these badge icons can thus provide, for example, information useful to contributors in deciding whether to contribute to this particular proposal and, if so, how much to contribute. The term “badge” is only used as a label to identify the type of information conveyed by the corresponding icon. A section 134 can display information about the requestor, for example a photo of the requestor and the requestor's name, assigned division within the entity, and geographic location.

A section 136, corresponding with funds gauge 97, can display an indication of the current funding obtained for the proposal and the total amount of funds requested. In this example, section 136 displays a bar that increases in length as funds are obtained, and the total length of the bar indicates the amount of funds requested. The amount funds currently obtained and the amount requested can also be displayed in text adjacent the bar. A section 138, corresponding with time gauge 99, can display an indication of the time remaining to raise funds for this proposal, in this example the number of days remaining. A section 140 can display an indication of the status of the proposal, in this example the status being the proposal is in the process of obtaining funds and has not yet been approved. Section 140 can be updated to display an indication of other status for the proposal, for example the proposal having been approved or completed. A section 142 can describe the proposal or idea for a project submitted by the requestor, and the proposal in section 142 can be described in text, photos, video, or other multi-media content. Section 142 can optionally include a link (electronic network address) to additional information about the proposal.

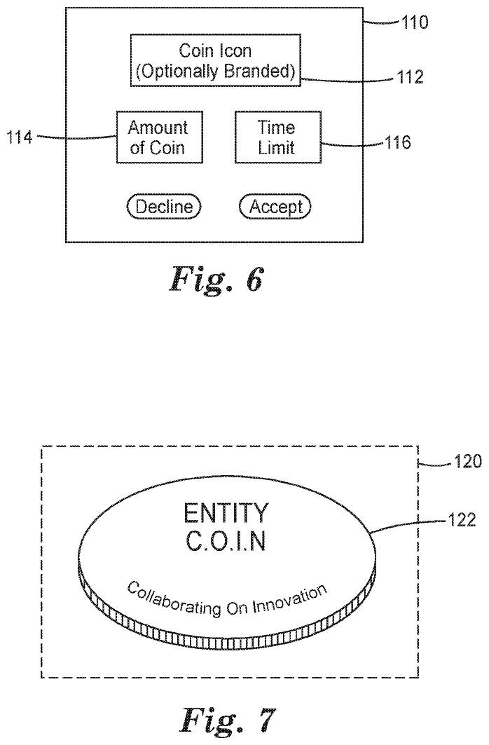

A section 144 can display an indication of the amount of coin available to the requestor for use in contributing to proposals. For example, each shaded icon in section 144 can correspond with a particular amount of coin available to the requestor for contributing to proposals. For example, each shaded icon can represent one hundred coins, and the value represented by each icon in section 144 can also be displayed. The icons in section 144 are shown as shaded and non-shaded circles for exemplary purposes, and these icons can be stylized as illustrated in FIGS. 6 and 7, as described below. A section 146, corresponding with bank gauge 95, can display an indication of the total amount of funds available in the bank. In this example, section 146 displays a bar that decreases in length, and a series of bars that decrease in illumination, as funds from the bank are used to contribute to this proposal.

User interface 130 can thus display a time gauge in section 138 visually indicating an amount of time remaining to obtain a requested amount of funds for the project, display a funds gauge in section 136 visually indicating an amount of funds currently obtained for the project, and display a bank gauge in section 146 visually indicating an amount of funds available for the project by contributors eligible for using the bank funds to make contributions to the project. User interface 130 can also display changes in the funds gauge and the bank gauge during the amount of time remaining, indicated by the time gauge, as contributions are received for the project, where the displayed changes in the funds gauge and the bank gauge correspond with the received contributions. The time gauge, funds gauge, and bank gauge can also be implemented with various colors to further visually indicate the status of, respectively, time remaining, current funds obtained, and funds remaining in the bank. The contributors to the proposal identified in section 142 can possibly have access to user interface 130 to monitor the status of the proposal and view the gauges for the proposal.

The entity records the proposal via entity computer systems 26 (step 34) in method 30 of FIG. 2. The entity also determines whether to approve the proposal for crowd funding. Whether to approve the proposal can be determined by, for example, a committee with members who have voting rights to approve or deny proposals. If the proposal is denied, the entity can send a denial message such as via email to the requestor via network 24 from entity computer systems 26 (step 36). The proposal can be denied if, for example, all the syntax or information for the proposal is not complete, even though the idea itself would be approved. The review of the proposal to determine whether to approve or deny it would occur to determine if the proposal is complete and not to limit the idea, although in some embodiments the review can occur to approve or deny the actual idea proposed. If the proposal is approved, the entity broadcasts the proposal to potential contributors (step 38). The proposal can be broadcast as an email to eligible contributors for the project, or the proposal can be posted on an internal web site for the entity, and a message such as an email or text message can be sent to eligible contributors notifying them of the proposal.

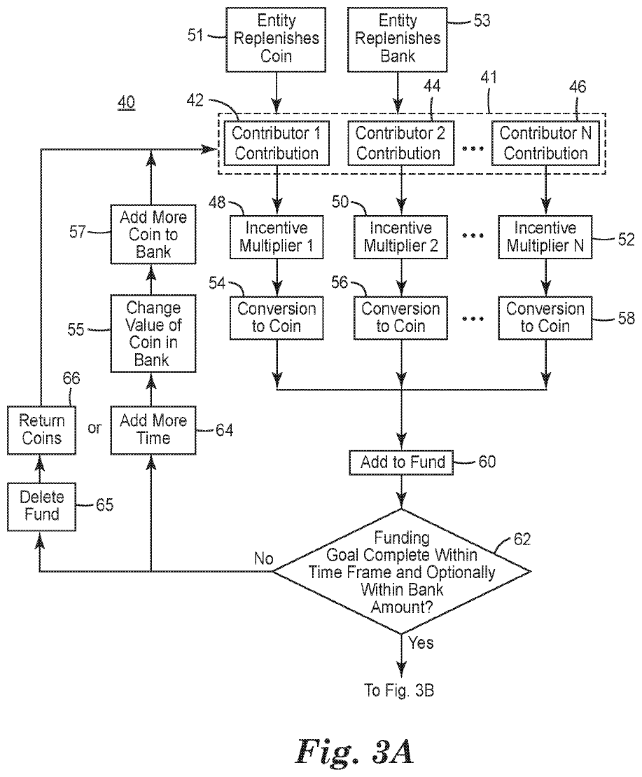

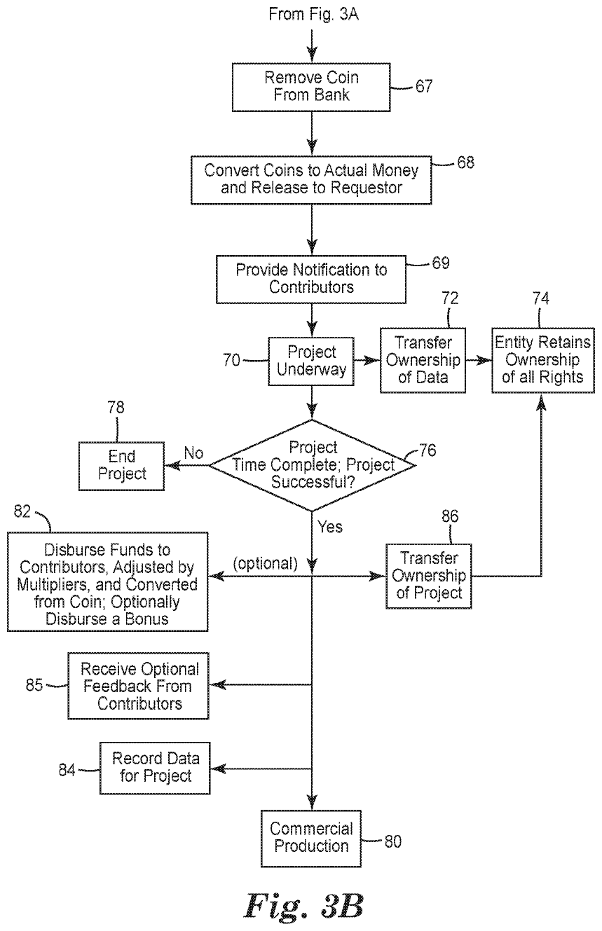

FIGS. 3A and 3B are a flow chart of a method 40 for incentivized crowd funding. Method 40 can be implemented in software for execution by the contributor computers 10, 20, and 22, and entity computer systems 26. In method 40, the pool of potential contributors 41, as represented by contributions 42, 44, and 46, can view a proposal and make a contribution to fund it. Only three contributions are shown for illustrative purposes; the funding could come from a wide range of the number of contributors. A contributor can be, for example, a person such as an employee or consultant of the entity. The contributors can also be, for example, a group of persons such as a team of employees of the entity.

FIG. 5 is a diagram of a user interface 100 for making a contribution to a proposal. User interface 100 can be displayed on an electronic display device of a computer for the contributor to make a contribution. User interface 100 includes a section 102 to identify the contributor, a section 104 to identify the proposal to which the contributor is making a contribution, and a section 106 to indicate the amount contributed to this proposal. The amount contributed can be billed to the contributor or assessed as a payroll deduction, for example. If the contributor is providing coin for the funding, then the amount of the contribution can be deducted from the contributor's coin account. User interface 100 can also include a section 107 to display an indication of the contributors remaining amount of coin, and a section 109 to display an indication of the time remaining for the contributor to spend the coin on proposals. The virtual coins represented in section 107 can also include coins from the bank available to fund this proposal and available to this contributor for funding it.

Each of the contributors' contributions 42, 44, and 46 can be selectively subject to corresponding incentive multipliers (steps 48, 50, and 52, respectively). Incentives are provided in part by multipliers that can increase the potential return based upon particular criteria such as the country where a contributor is based, the group or division to which a contributor is assigned, the number of successful projects to which the contributor has contributed, or other criteria to encourage participation by certain individuals or groups. As an example, the incentive multiplier can be 1.5 or 2.0 so that, if a project is successful, the corresponding contributor receives 1.5 times or twice the original contribution, respectively. Instead of using corporate or entity funds to make one large internal grant, the corporate funds can be used to encourage participation by offering a potential return based upon the incentive multipliers. When a proposal is broadcast, the entity can optionally include an identification of incentive multipliers for the project. For example, if the entity wants to encourage participation by employees of the entity based in Europe, the entity can indicate that any contributor based in Europe will receive an incentive multiplier along with an indication of such multiplier. As another example, if the entity wants to encourage participation by employees who work in the same group or division as the requestor, the entity can indicate that any of those employees as contributors will receive an incentive multiplier.

Also, to provide for raising many small amounts of money, the individual contributions, represented by contributions 42, 44, and 46, can be limited to a certain percentage of the fund goal (amount requested), for example 5% or 1%. For example, if the requested amount of funds is $10,000, the entity can limit individual contributions to 5% of that amount or $500. As another example, the entity can establish a monetary limit such as $100 for each contribution to a proposal. Other percentages or monetary limits are possible, if used. These limits can help to encourage participation by a large number of contributors as often desired for crowd funding. If an individual contribution exceeds the limit, when used, then the contribution is not accepted, and the corresponding contributor can possibly be notified that the attempted contribution exceeded the limit.

The contributions 42, 44, and 46, after selectively adjusted by the incentive multipliers, are converted to a corresponding amount of coin (steps 54, 56, and 58, respectively), and the resulting amounts are added to the fund in step 60. Coin can be used as artificial or virtual currency. In particular, coin is a digital currency amount representing a fiat currency amount preferably in a single currency. Tokens are also a digital currency amount representing a fiat currency amount. Tokens can be used instead of, or in addition to, coin in the crowd funding process. Coin can also be branded to convey specific corporate messages or link the history of the organization (entity) to significant people or events in the life of the organization. Coin thus provides a way to convert contributions in a variety of currencies to a universal monetary unit, as well as communicate to requestors and contributors.

The existing currency exchange rates can be used to convert from a contributor's currency to coin, or artificial exchange rates can be generated for conversion to coin. The exchange rate used to convert to coin is saved to later potentially convert back to currency when funds are disbursed for successful projects. The type of currency for coin can be, for example, the currency of a requestor's country. For example, if the requestor is based in the United States, then the coin can represent US dollars for this requestor's fund, and the contributor's contributions, if not in US dollars, are converted from the currency of origin to US dollars. For example, if a contributor is based in Europe and the requestor is based in the United States, the contributor's contribution can be converted using the current exchange rate (at the time of the contribution) from euros to US dollars. The artificial exchange rates, if used, can be another way to provide incentives by establishing exchange rates between particular currencies greater than existing exchange rates.

Furthermore, instead of contributing fiat currency, it is possible for contributors to earn coin through particular activities such as presenting a technical paper, the contributors' number of granted patents, or the contributor's rating as determined by performance reviews. The earned coins can optionally have an expiration date, for example at the end of the current fiscal year for the entity.

Instead of, or in addition to, earning coin the entity can distribute coin to the pool of potential contributors 41 in step 51. In particular, the entity can replenish coins to the pool of contributors. The entity can also replenish coin in the bank in step 53. The bank can represent a total amount of coin available for funding proposals, possibly with limits concerning contributors who may use the coin in the bank, proposals for which the contributors may use the coin in the bank, and an amount of coin in the bank each eligible contributor may use to fund projects. For example, the total amount of coin in the bank can be reserved for use by only employees within a particular division of the company with each of those eligible employees allotted only a certain amount of coin in the bank and, as another example, for use only within a particular time frame. As other examples of such limits, the coin in the bank can be limited for use only by employees within a particular geographic region or only by employees who have previously contributed to a particular number of successful projects. The bank can thus include several banks of coin based upon these limits, for example. The entity can replenish coin in the bank for step 53 on a regular basis, for example the entity can replenish the bank every calendar quarter or every fiscal quarter for the entity. The entity can also replenish the coin in the bank at other times or according to other criteria.

The coin and bank in steps 51 and 53 is typically owned by the entity. In other embodiments, the coin and bank can be owned by a different entity, and contributors (e.g., employees and contractors) of the entity use the coin and bank to perform work for the different entity. That coin and bank can optionally be branded or labeled by the different entity. In this manner, the different entity essentially funds the work through its coin that the entity performs for the different entity. For example, one company performs work for and funded by another company. This embodiment can also include the entity performing work for many different entities with each different entity having and owning its own coin and bank, which can be securely traced via blockchain operations as described below. The entity can still own the ideas and set the incentive multipliers for the process when performing work for and funded by a different entity through coin and bank owned by the different entity.

This distributed coin, and possibly the earned coin and the coin in the bank, can be owned by the entity and licensed to the contributors with the license specifying how the coin can be used and a time limit on it. For example, the license can include the following terms: the coin can only be used to fund eligible requestors' proposals; the coin represents a value of fiat currency but has no monetary value itself; and the coin must be used within the current fiscal year of the entity, otherwise the coin expires.

FIG. 6 is a diagram of a user interface 110 for distributing or sending coin to a pool of potential contributors. User interface 110 can be displayed on an electronic display device of a computer for potential contributors to receive the coin. User interface 110 includes a section 112 to display a coin icon representing coin, a section 114 to display the amount of coin (number of units) to be distributed or sent to a potential contributor, and a section 116 to display a time limit for using the distributed coin. If the coin is licensed to the potential contributor, the contributor can select the accept button on user interface 110 to accept the terms of the license and receive the coin into the contributors coin account subject to the license. The contributor could view the license terms in user interface 110 or another associated user interface. The value of the coins distributed can be based upon, for example, a particular proposal. As an example, if the requestor for a proposal is based in the United States, then one coin (one unit) can equal one US dollar. As another example, if the requestor for a proposal is based in Europe, then one coin (one unit) can equal one European Union euro.

As indicated above, the coin can optionally be branded. FIG. 7 is a diagram of an exemplary icon 122 for coin to be displayed on an electronic display device or screen represented by dashed line 120, for example as the coin icon 112 in user interface 110 or the coin icons in section 144 of user interface 130. This exemplary icon 122 resembles a monetary coin and can include the entity name or brand, possibly stylized, along with a message as shown.

Entity computer systems 26 determine if the funding goal is complete within the specified time frame for contributions and optionally within a total amount in the bank available for this proposal (step 62) in method 40 of FIGS. 3A and 3B. If the funding goal is not complete, entity computer systems 26 can add more time for raising funds (step 64), or delete the fund (step 65) and return any coins to the contributors (step 66). Deleting the fund in step 65 means that the contributors are not charged with the amounts of fiat currency they had proposed contributing, and if the contributors originally used earned coin as the proposed contribution, those coins are returned to the contributors coin account in step 66. If more time is added to raise funds, the requestor can optionally refine the proposal and resubmit it.

In addition, if more time is added in step 64, the entity can also change the value of the coin in the bank for this proposal (step 55) or add more coin to the bank for this proposal (step 57), or perform both steps 55 and 57. Changing the value of the coin in the bank for this proposal can effectively increase the amount of funds available for it. For example, the entity can initially set the value of the coin in the bank as one coin represents one US dollar and then change the value of the coin in the bank as one coin represents ten US dollars. In some cases, the entity may change the value of the coin in the bank for this proposal by decreasing the value, for example if more coin is added to bank for funding this project.

If the funding goal is complete within the time frame (step 62), entity computer systems 26 convert the coins for the proposal to fiat currency and release the money to the requestor (step 68), and the project is underway (step 70). If coin from the bank was used to fund this proposal, entity computer systems 26 remove a corresponding amount of coin from the bank (step 67). Also, entity computer system 26 can provide a notification to contributors that the proposal to which they contributed has met its funding goal and the corresponding project is underway (step 69). This notification can include, for example, an email message, a posting on an internal web site, and a change in the status in section 140 of user interface 130.

By using coin to represent a digital currency amount, fiat currency for the funds can optionally be locally released to the requestor in the country where the requestor is based. For example, if the entity is based in the United States but the requestor is based in Europe, the entity can instruct a European division of the entity to release the fiat currency to the requestor rather than transferring money from the United States to a European location or account. The fiat currency can be released by, for example, providing an electronic transfer of funds to the requestor's bank account or by issuing a check to the requestor. Furthermore, by using coin to represent a digital currency amount, the fiat currency for the project is only expensed when the project is approved, for example.

Upon beginning the project, the requestor transfers ownership of the data for the project to the entity (steps 72 and 74). Transferring ownership of the data can include transferring intellectual property rights in the data such as any applicable patent, copyright, trademark, and trade secret rights. As the project is underway, a status of the project can be provided to the contributors by, for example, an email message or electronic posting, allowing the contributors to track the progress of the projects to which they have contributed.

When the project time is complete, it is determined whether the project was successful (step 76). If the project was not successful, the project ends and no funds are returned to the contributors, having taken the risk of funding the project (step 78). If the project was successful, the project can possibly enter commercial production by the entity (step 80). A project can be deemed successful if, for example, the project can result in a commercial product for the entity, if the project results in a working prototype, or according to other criteria. Also, the requestor transfers ownership of the project to the entity (steps 86 and 74). Transferring ownership of the project can include transferring ownership of any resulting prototypes or other physical items and transferring intellectual property rights in the project such as any applicable patent, copyright, trademark, and trade secret rights.

Entity computer systems 26 record data for the project (step 84) and optionally disburse funds to the contributors, adjusted by the corresponding incentive multipliers, and converted from coin to the contributors' currencies using the corresponding conversion rates (step 82). When step 82 is executed, the funds or bonus can be disbursed by, for example, electronic transfers to the contributors' bank accounts or by issuing checks to the contributors. If the project was funded with coins distributed to the pool of potential contributors, then the entity may not execute step 82. If the project was funded in part by contributors money converted to coin, then the entity may elect to execute step 82 for those types of contributions. Alternatively for step 82, the contributors, or selected ones of the contributors, can receive a type of bonus, for example a monetary bonus or an increase in virtual coins to reinvest in other projects with the coins being deposited into the contributors' coin accounts. Another type of bonus can involve rewarding successful investors, meaning the contributors who have contributed to projects deemed successful. A contributor's number of successful projects can be tracked, and the contributors who contribute to such successful projects can be rewarded with additional or increasing amounts of virtual coin to reinvest in other projects. This bonus for contributing to successful projects can be, for example, a set amount of coin for each successful project or increasing amounts of coin based upon the number of successful projects. Therefore, those contributors who have a proven record of contributing to successful projects can be rewarded with more coin and encouraged to invest in more proposals they believe will result in successful projects.

Furthermore, if the project was successful, entity computer systems 26 can receive optional feedback from the contributors for the proposal corresponding with this project (step 85). Feedback from the contributors to the project can include the following information: an up vote indicating approval of the completed project; a down vote indicating disapproval of the completed project; an indication that the project did not meet the contributors' expectations; or an indication that the project exceeded the contributors' expectations. The feedback can be provided, for example, in a user interface such as part of user interfaces 100 or 130.

Security features can be incorporated into this crowd funding system based upon various criteria such as groups or geographic regions. For example, if a proposal is only available for funding by contributors within a particular group or division of the entity, then only those contributors can be granted access to information about the proposal. As another example, if a proposal is only available for funding by contributors within a geographic region, then only those contributors within that geographic region can be granted access to information about the proposal.

Table 1 provides an example of a data structure for granting coin to contributors based upon particular activities. Table 2 provides an example of a data structure for recording conversion rates for converting contributions to a corresponding amount of coin. Table 3 provides an example of a data structure for recording data for contributions for a particular project. Table 4 provides an example of a data structure for recording coin distributed to potential contributors. Table 5 provides an example of a data structure for recording project data. Table 6 provides an example of a data structure for a bank of coin, divided into multiple banks, where each bank has a group of requestors eligible for having coin from the bank used for their proposals and groups of contributors eligible for using coin from the bank for contributing to those proposals. Tables 1-6 are representative of data structures to be stored in a computer memory or electronic database for access by the entity computer systems or other computers.

TABLE 1
Earned Coin Amounts

| Activity | Amount of Coin |
|---|---|
| activity 1 | amount 1 |
| activity 2 | amount 2 |
| . . . | |
| activity N | amount N |

TABLE 2
Conversion Rates

| Type of Currency | Rate for Conversion to Coin |
|---|---|
| Coin | 1 |
| currency 1 | current rate for currency 1 OR artificial rate 1 |
| currency 2 | current rate for currency 2 OR artificial rate 2 |
| . . . | |
| currency N | current rate for currency N OR artificial rate N |

TABLE 3
Project Contributors

| | | | Incentive | Conversion |
|---|---|---|---|---|
| Contributor | Country | Contribution | Multiplier | Rate |
| contributor ID 1 | country 1 | amount 1 | multiplier 1 | rate 1 |
| contributor ID 2 | country 2 | amount 2 | multiplier 2 | rate 2 |
| . . . | | | | |
| contributor ID N | country N | amount N | multiplier N | rate N |

TABLE 4
Coin Distribution

| | Amount (Number | Expiration |
|---|---|---|
| Pool of Potential Contributors | of Coins) | Date |
| contributor ID 1 | amount 1 | date 1 |
| contributor ID 2 | amount 2 | date 2 |
| . . . | | |
| contributor ID N | amount N | date N |

TABLE 5
Project Data

| Project ID | Requestor | Amount of Coin Received | Product |
|---|---|---|---|
| project 1 | requestor 1 | fund 1 | product 1 |
| project 2 | requestor 2 | fund 2 | product 2 |
| . . . | | | |
| project N | requestor N | fund N | product N |

TABLE 6
Bank of Coin

| | Amount | Value | Eligible | Eligible |
|---|---|---|---|---|
| Bank | of Coin | of Coin | Requestors | Contributors |
| bank 1 | amount 1 | value 1 | requestors 1a, | contributors 1a, |
| | | | 1b, . . . 1n | 1b, . . . 1n |
| bank 2 | amount 2 | value 2 | requestors 2a, | contributors 2a, |
| | | | 2b, . . . 2n | 2b, . . . 2n |
| . . . | | | | |
| bank N | amount N | value N | requestors Na, | contributors Na, |
| | | | Nb, . . . Nn | Nb, . . . Nn |

The crowd funding method described above can be implemented, for example, as a software application integrated with existing entity computer systems. The entity controls the process in part by owning the proposal, the project, and coins for it. The entity also owns the intellectual property rights covering the proposal and the project, providing an incentive for the entity to commercialize successful projects. This crowd funding method thus provides a specific type of crowd funding that may be useful for organizations as a way to fund innovation and internally develop ideas, aside from the more commonplace ways organizations fund research and development.

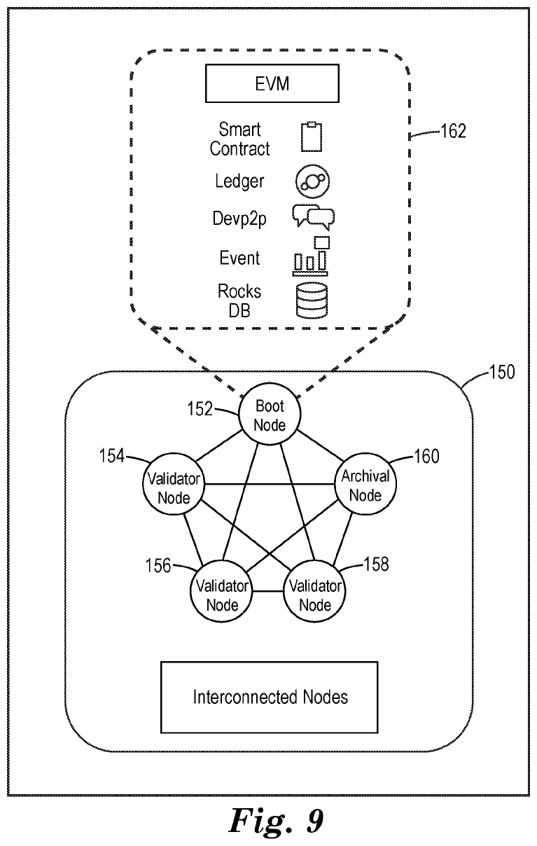

FIG. 9 is a diagram of a blockchain structure for the crowd funding system described above. Embodiments with blockchain include the combination of a crowd sourced idea generation electronic web site with crowd sourced funding for corporate innovation. The security and automation of such a valuable data set that includes real funds has been solved with the addition of blockchain elements.

Hosting the crowd funding system on blockchain enables the automation of key administrative tasks, such as the immediate generation of a project number for project spending at the moment when a project reaches its specified funding request level. This feature automates a manual task and accelerates project timelines, and even more importantly gives project submitters and investors confidence that their idea will be funded by the entity if it is validated by their crowd funding investment peers. The ability to guarantee immediate funding without weeks and months of project reviews, for example, can energize participants or contributors to put their innovative ideas forward where they might otherwise hold back because they may not believe they will receive approval to try out their ideas.

Leveraging blockchain for the crowd funding system enables the creation and marketing of an entity-branded innovation coin, which can show that the entity is on the leading edge of innovation digital transformation. Creating an entity-branded coin which can be transacted on blockchain provides added incentive for participants or contributors to use the innovation site hosting the crowd funding system. The creation of an innovation coin, such as the coin described above, can further provide a marketing opportunity for the entity, which increases the potential to monetize and license the innovation platform to external companies for their own crowd funding initiatives.

Executing the crowd funding system and process on blockchain provides security and traceability for the project submission and crowd funding process. For budget contributed to the innovation platform, it is important to know how and where the money is being spent. For investors, it is similarly important to know with certainty that their voice is being heard through the contribution of their coins. The automation, security, immutability, and transparency of blockchain enables each of these objectives while also allowing the program to be easily scaled to multiple investing parties.

As shown in FIG. 9, the platform can have 5 nodes with following breakdown: node 152—boot node, validator node, node 160—archival node; node 154—validator node; node 156—validator node; and node 158—validator node. These nodes can be implemented with, for example, known blockchain structure and operations.

Validator nodes (154, 156, 158): Validator nodes are those that participate in the consensus protocol. They are responsible for the generation of new blocks. Validator nodes are only connected to each other and to boot nodes for security and efficiency purposes. Validator nodes apply the IBFT2.0 consensus protocol to validate the transaction and incorporate it into a new block.

Boot nodes (152): Boot nodes are responsible for setting up new nodes by providing them with a list of active nodes in the network and other relevant information such as whitelists and blacklists. Boot nodes are connected to all the types of nodes in the network. In a simpler construct, Boot nodes are used to initially discover peers. A boot node is a regular node to which nodes connect on startup. Boot nodes include the elements shown in block 162 in a Ethereum Virtual Machine (EVM).

Full nodes: Full nodes have the current state of the blockchain so cannot serve the network with all data requests (e.g., the balance of an account at an old block).

Archival nodes (160): Archival nodes have all features of full nodes and they also store the intermediary state of every account and contract for every block since the genesis block. An archival node has the functionality of a fill node, and it can access historical state data.

Peer-to-peer (P2P) networking. For P2P networking, Besu implements the devp2p Ethereum network protocol. The protocol ensures inter-client communication. It also acts as an additional IBFT2 sub-protocol. The discovery is made using UDP-based protocol. For communication, it utilizes the RLPx—a TCP-based protocol. The RLPx, on the other hand, uses various sub-protocols including the ETH Wire Protocol (for transaction state synchronization) and IBF sub-protocol (for making consensus decisions).

Badge/Coin/Token Creation/Development. There can be 2 types of tokens for the blockchain platform for the crowd funding system: Fungible tokens—coin; and non-fungible tokens—badges. Badges can be awarded to successful inventors in the crowd funding system and can thus be used as an incentive multiplier, for example providing more coin to the successful inventors.

Fungible tokens: Coin or entity innovation coin is a branded token, digital currency, or stable coin standard token associated with actual currency, such as U.S. dollars, that does not change significantly in value. Coin can be implemented as described above for the crowd funding system.

Table 7 includes an example of key elements of a smart contract for innovation token creation. In this example of a smart contract, the public price of coin has a value 1. Furthermore, functions can be used for a life cycle of fungible tokens.

TABLE 7
Smart Contract Elements

contract InnovationCoin is ERC2@ {
address public admin;
constructor(
uint initialSupply
) ERC20( “InnovationCoin ”
INC”) {
mint (msca . sender,
initialSupply *
admin-
msg . sender,
(decimals( )) ) ;
At Address
OR
Load contract from Address
Transactions recorded
Deployed Contracts
V INNOVATIONCOIN AT OX61d...F7EE8
function mint(
address to,
uint amount
external {
rpquyre(msp. sender admin,
mint(to, amount);
‘only admin is allowed to mint’)
approve
address spender. uint25E
uint25E amount
address spender. uint256
address spender. uint25E
function burn(
uint amount

Non-Fungible Tokens (NFTs): Badges are such NFTs that feature unique characteristics and cannot be exchanged or replaced with identical tokens. Smart contracts inside the NFTs help in storing the unique and exclusive data that differentiate NFTs from other tokens which are also known for indivisibility. Badges are individual tokens with extra information stored in them. Each badge contains owner identification (ID), rich metadata, safe file links, and other identifying information that is recorded in its smart contract. Badges can be drafted or generated, for example, via the ERC721 standards for facilitating NFTs requirements.

The blockchain structure of FIG. 9 can be implemented within the crowd funding system of FIG. 1 (e.g., contributor and entity computers) and processes of FIGS. 2 and 3A-3B in order to provide for secure and traceable transactions throughout the process. The blockchain structure and crowd funding system can be applied both within a single entity or company to encourage idea development and also between multiple entities or companies to incentivize and execute crowd sourced innovation. In each of these cases, the blockchain structure and crowd funding system provide the traceable, immutable record of investment required to enable multi-entity collaboration. The blockchain structure and crowd funding system also provide the administrative automation to enable crowd sourced innovation across one or more entities at enterprise scale. The blockchain structure can also generate the coin such that each coin is unique and traceable throughout the process. When the entity replenishes the coin in step 51 and the bank in step 53, adds more coin in step 57, changes the value of coin in step 55, each new coin is subject to a blockchain operation in order to uniquely identify it and subsequently trace it via the unique identifier. The incentive multipliers in steps 48, 50, and 52 can also be subject to blockchain operations to uniquely identify and trace the multipliers for the corresponding contributors.

The transactions in the process of FIGS. 3A and 3B can also be subject to a blockchain operation to uniquely identify them, for example the transactions in steps 54, 56, and 58 to convert coin, steps 65 and 66 to delete the fund and return coins, step 60 to add converted contributions to the fund, step 67 to remove coin from the bank, steps 68 and 69 to release the fiat currency and provide notification to the contributors, step 82 to disburse the funds, and step 86 to transfer ownership. Other steps or transactions in the crowd funding process can also be subject to blockchain operations to uniquely identify them and trace them through the process.

Table 8 is an example of a blockchain immutable record for applying unique identifiers in the crowd funding system. The immutable records can be distributed and tagged to one another among the entity and contributor computers to provide security by, for example, using the unique identifiers to verify coin, incentive multipliers, badges, and transactions. Table 9 is an example of blockchain operations for the crowd funding system. The immutable record and blockchain operations can be implemented with, for example, known blockchain records and operations.

TABLE 8
Blockchain Immutable Record
Coin

| | |
|---|---|
| coin 1 | unique coin identifier 1 |
| coin 2 | unique coin identifier 2 |
| . . . | |
| coin N | unique coin identifier N |

Badges

| | |
|---|---|
| badge 1 | unique badge identifier 1 |
| badge 2 | unique badge identifier 2 |
| . . . | |
| badge N | unique badge identifier N |

Incentive Multipliers

| | |
|---|---|
| incentive multiplier 1 | unique multiplier identifier 1 |
| incentive multiplier 2 | unique multiplier identifier 2 |
| . . . | |
| incentive multiplier N | unique multiplier identifier N |

Transactions

| | |
|---|---|
| transaction 1 | unique transaction identifier 1 |
| transaction 2 | unique transaction identifier 2 |
| . . . | |
| transaction N | unique transaction identifier N |

TABLE 9
Blockchain Operations

apply unique identifiers to coin
apply unique identifiers to badges
apply unique identifiers to incentive multipliers
apply unique identifiers to transactions
save unique identifiers in nodes or blocks
verify unique identifiers for coin, badges, incentive
multipliers, and transactions
authorize or decline operations based upon the verification
tag immutable record to next node or block

1. A computer-implemented method of crowd funding for innovation involving one or more entities, comprising steps of:
distributing via a computer system a proposal with a description of a project, an amount of funds requested, and a time frame for raising the funds;
transferring ownership of the project to an entity or between entities;
receiving by the entity via the computer system contributions from contributors and for each of the contributions received:
converting the contribution to a corresponding amount of coin according to a conversion rate, wherein the coin is a digital currency amount representing a fiat currency amount;
performing a blockchain operation on the coin; and
adding the adjusted contribution to the funds;
releasing via the computer system from the entity or entities to the requestor an amount of money corresponding with the amount of coin in the funds if the funds satisfy the amount of funds requested within the time frame and within a bank amount of funds available for the project; and
determining if the project is successful after the money is released.

2. The method of claim 1, wherein the receiving step further comprises selectively adjusting the contribution by an incentive multiplier and performing a blockchain operation on the incentive multiplier.

3. The method of claim 2, further comprising the step of, if the project is successful, distributing the funds by the entity or entities to the contributors, adjusted by the corresponding incentive multipliers, and converted from the coin by the corresponding conversion rate.

4. The method of claim 3, wherein the distributing the funds step comprises disbursing the funds converted from coin using the same exchange rates used to convert the contributions to the coin.

5. The method of claim 2, wherein the adjusting step comprises multiplying the contribution by a value greater than one and less than or equal to two as the incentive multiplier.

6. The method of claim 1, wherein the converting step uses current exchange rates at the time of the contribution as the conversion rate from a currency of the contributor country to a currency of the requestor country.

7. The method of claim 1, further comprising limiting each of the contributions to no more than a particular percentage of the amount of funds requested.

8. The method of claim 1, wherein the converting step comprises using a single type of currency for the coin.

9. The method of claim 1, wherein the transferring step includes transferring intellectual property rights in the project to the entity or between entities.

10. The method of claim 1, further comprising making available to a pool of potential contributors a particular amount of coin in the bank.

11. The method of claim 1, further comprising the step of sending to a pool of potential contributors particular amounts of the coin.

12. The method of claim 11 wherein the sending step further comprises licensing the particular amounts of the coin to the pool of potential contributors, wherein the license restricts usage of the coin to crowd funding of projects within the entity or entities and specifies a time limit when the coin can be used for the crowd funding.

13. The method of claim 11, wherein the sending step comprises electronically displaying a user interface to distribute the particular amounts of coin.

14. The method of claim 13, wherein the sending step further comprises displaying within the user interface an amount of coin and a time limit to spend the amount of coin.

15. The method of claim 1, wherein the distributing step comprises electronically displaying a user interface identifying the proposal.

16. The method of claim 15, wherein the distributing step further comprises displaying within the user interface an indication of the funds received for the proposal and a time remaining in the time frame.

17. The method of claim 1, wherein the receiving step comprises electronically displaying a user interface to receive the contributions.

18. The method of claim 17, wherein the receiving step further comprises displaying within the user interface an amount of coin remaining for the contributor and a time remaining to spend the remaining coin.

19. The method of claim 1, further comprising the step of, if the project is successful, distributing by the entity or entities to the contributors, or selected ones of the contributors, a bonus comprising a set amount of coin.

20. The method of claim 1, further comprising the step of, if the project is successful, receiving from the contributors feedback relating to the project.

21. (canceled)
